(19) United States
(12) Patent Application Publication
(10) Pub. No.: US 2009/0096597 A1
(43) Pub. Date: Apr. 16, 2009

(54) DRIVER INTERFACE UNIT

(76) Inventors: Richard M. Avery, JR., Battle Creek, MI (US); David L. Flood, Mattawan, MI (US); John P. Repyak, Portage, MI (US); Alan W. Dudycha, Paw Paw, MI (US); Robert O. Anderson, Kalamazoo, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/870,782

(22) Filed: Oct. 11, 2007

(51) Int. Cl. B60Q 1/00

(52) U.S. Cl. 340/435; 340/459

(57) ABSTRACT

A system and method for detecting a plurality of vehicle conditions are disclosed. A system may include a plurality of inputs indicating a corresponding plurality of vehicle conditions, and a driver interface unit in communication with the inputs. The driver interface unit is operable to output one or more indicators associated with each vehicle condition, and to modify one of the indicators such that the driver interface unit outputs the modified indicator and the other indicators.

### BACKGROUND

A wide variety of electronic controls and systems that generate information for a vehicle operator have been developed in recent years for use in motor vehicles. For example, many complex vehicle systems such as adaptive cruise control systems, collision warning systems, and lane departure warning systems have been developed, and are particularly useful for heavy duty vehicle applications. Each system may require varying levels of driver interaction, and provide information to a vehicle operator regarding conditions pertinent to the particular system, such as alerts, warnings, indicators, etc. For example, a collision warning system may alert the driver when the presence of a slow-moving vehicle within a predetermined distance in front of the host vehicle is detected by displaying a warning light or message on a display screen. As another example, a lane departure warning system may detect that a vehicle is drifting out of its lane of travel, and notify the driver to maintain their lane position with an audible alert. Each of the systems may provide an indicator or alert that notifies the driver of an associated condition when the condition is detected by the relevant vehicle system. Given the increasing number of systems that may provide alerts or other information, a driver may be faced with a large number of alerts at a given time, e.g., warning lights, audible alarms, or tactile feedback through vehicle controls.

Integrating the wide array of known systems in a cohesive manner has proven challenging, due primarily to the disparate purposes of each system, the varying levels of significance to the driver of the alerts associated with each system, and the different forms the notifications may take. A vehicle operator may thus easily be overwhelmed by the array of alerts, messages, and indicators provided by the many systems, especially for operators not experienced with each individual system. As a result, some of the systems may lose their effectiveness at alerting a driver to potentially dangerous conditions and, worse, may confuse the driver, especially when more than one condition requiring driver notification is present. Some vehicle systems have been developed in response to suppress information regarding conditions that may not be as urgent in favor of higher priority alerts indicating conditions requiring immediate driver intervention. However, these systems, by their very nature, eliminate at least a portion of information that would otherwise be provided to the driver. Accordingly, although such systems may provide higher priority warnings more clearly by eliminating clutter caused by less important warnings, they withhold other information from the driver that would nonetheless be useful, regardless of its lesser priority in the face of other more pressing conditions.

Accordingly, there is a need in the art for a system that notifies a vehicle operator of all relevant conditions detected by various vehicle systems without causing confusion to the driver or withholding information regarding less important conditions.

### BRIEF DESCRIPTION OF THE DRAWINGS

While the claims are not limited to the exemplary illustrations, an appreciation of various aspects is best gained through a discussion of various examples thereof. Referring now to the drawings, exemplary illustrations are shown in detail. Although the drawings represent illustrated approaches, the drawings are not necessarily to scale and certain features may be exaggerated to better illustrate and explain an innovative aspect of one or more illustrations. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows.

FIG. 1 is a schematic view of a vehicle electronics system having a driver interface unit;

FIG. 2 is a front view of a driver interface unit;

FIG. 3 is a process flow diagram of a process for displaying alerts on a driver interface unit; and

FIG. 4 is a portion of the process flow diagram shown in FIG. 3.

### DETAILED DESCRIPTION

Reference in the specification to “an exemplary illustration”, and “example” or similar language means that a particular feature, structure, or characteristic described in connection with the exemplary approach is included in at least one illustration. The appearances of the phrase “in an illustration” or similar type language in various places in the specification are not necessarily all referring to the same illustration or example.

According to various exemplary illustrations described herein, a system and method are disclosed for providing a driver interface unit that detects a presence of a plurality of vehicle conditions, each of which associated with at least one indicator. The driver interface unit modifies at least one of the indicators received from the systems and displays the modified indicator(s) and any remaining indicators. Accordingly, the system generally displays indicators for all vehicle conditions that are present at a given time without suppressing the display of any vehicle conditions that are present, such that the information conveyed by the indicators may be generally easily understood by a vehicle operator.

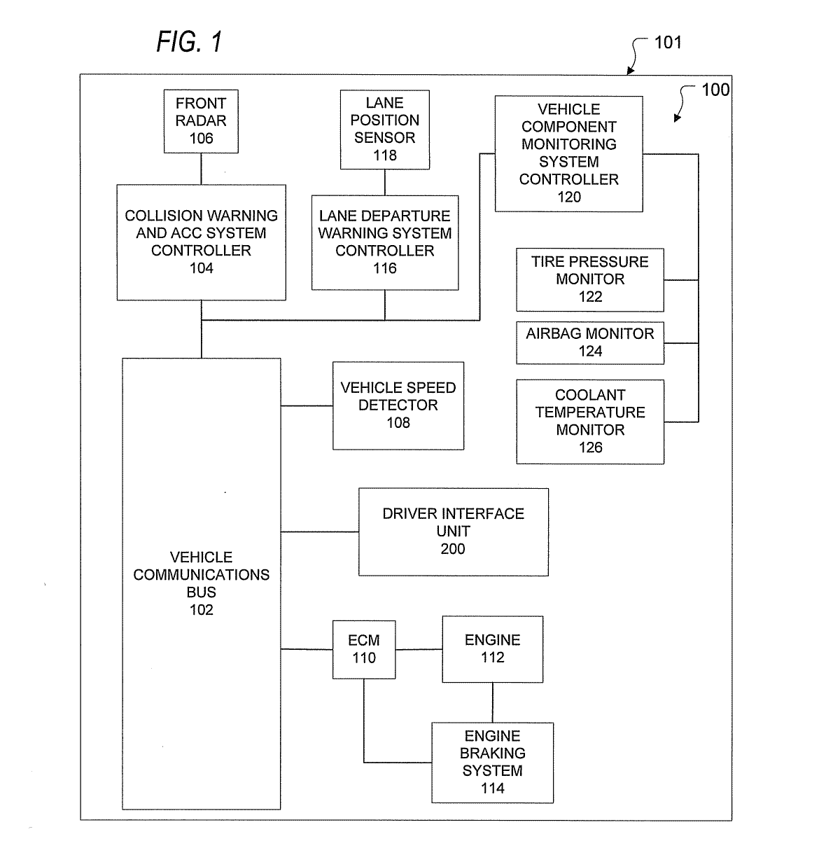

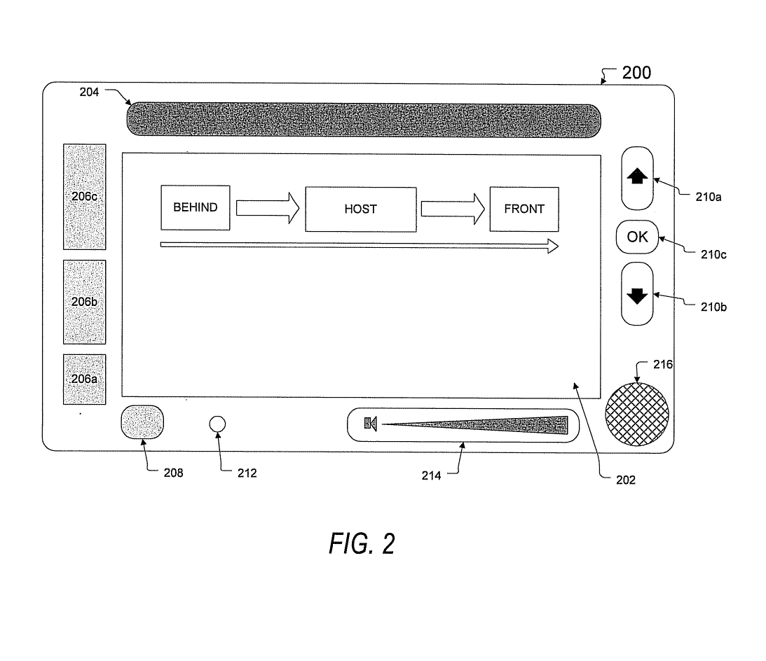

Turning now to FIG. 1, a schematic representation of a vehicle electronics system 100 for a motor vehicle 101 is illustrated. System 100 may generally include any number of vehicle systems that monitor driving and/or operating conditions of the vehicle, and notify an operator of the monitored conditions. For example, as shown in FIG. 1, system 100 may include various hardware and/or software elements, as described below, for providing a collision warning and adaptive cruise control subsystem, a lane departure warning subsystem, and a vehicle component monitoring subsystem. Any number of other known vehicle systems which provide warnings, alerts, or other information to a vehicle operator may be incorporated into system 100. Each of the various systems may be in communication with a driver interface unit (DIU) 200 (illustrated in FIG. 2) via a vehicle communications bus 102.

Vehicle communications bus 102 generally provides a centralized communication platform for vehicle subsystems linked with vehicle communications bus 102. Each vehicle subsystem linked to vehicle communications bus 102 may thereby receive or access any commands and/or information received or produced by other subsystems. Various types of known vehicle communications buses may be employed in vehicle 101. For example, vehicle communications bus 102 may operate according to the Society of Automotive Engineers J1939 standard, which is generally directed to communications systems for heavy duty vehicles.

As briefly described above, system 100 may include various hardware and/or software components for providing a collision warning subsystem. As shown in FIG. 1, system 100 may include a collision warning and Adaptive Cruise Control (CW/ACC) controller 104 in communication with vehicle communications bus 102. CW/ACC controller 104 may be linked with a radar device 106, which is operable to detect the presence of objects in the path of the vehicle 101.

In one exemplary illustration, a VS-400 SmartCruise® system manufactured by Eaton Corporation, located in Cleveland, Ohio, is employed. Additionally, other devices that detect objects in the path of vehicle 101 may be used instead of or in addition to radar 106. For example, a camera or other light- or heat-sensitive system may be used in place of radar device 106. Further, radar device 106 need not be connected directly to controller 104. For example, radar device 106 may be conveniently linked with vehicle communications bus 102 to communicate with CW/ACC controller 104 over vehicle communications bus 102.

CW/ACC controller 104 may also be in communication with a vehicle speed detector 108 over vehicle communications bus 102. Vehicle speed detector 108 generally provides a signal for indicating the speed of vehicle 101 to communications bus 102. Vehicle speed detector 108 may accomplish speed detection in a variety of ways. For example, vehicle speed detector 108 may measure the rotation of a wheel of vehicle 101, a gear of the vehicle transmission, an axle of the vehicle, etc. The foregoing indication of vehicle speed is typically provided for several other vehicle systems which rely on vehicle speed as a part of their operation. For example, a speedometer (not shown) typically is provided on vehicle 101 to indicate the vehicle speed to the operator, and generally receives an indication of the vehicle 101 speed via communications bus 102.

An engine control module (ECM) 110 generally governs and monitors operating parameters of an engine 112 in vehicle 101. ECM 110, as is known, may be connected with vehicle communications bus 102, and receive information from vehicle systems other than system 100 that may be useful for controlling the operation of engine 112. For example, ECM 110 may receive information from and generally interact with a transmission control module (not shown) of vehicle 101, as is common in many vehicles.

System 100 further may include an engine retarder or engine braking system 114, such as is typically included in many heavy duty vehicles. Engine braking system 114 provides a secondary braking system for vehicle 101, which may be used in combination with the vehicle brakes (not shown) to slow vehicle 101. Secondary braking systems are useful for preventing excess wear of the vehicle braking system as a result of the harsh operating conditions typical of brake systems for heavy duty vehicles. Engine braking system 114 may alter the timing of the intake and exhaust valves of one or more cylinders of the engine to at least reduce the speed of the crankshaft, and even provide a force acting in opposition to the rotation of the crankshaft, slowing the crankshaft more significantly. Engine braking system 114 thereby slows the speed of engine 112, which in turn slows vehicle 101 through the transmission (not shown).

Various hardware and/or software components may be included in system 100 to provide a lane departure warning system. For example, as shown in FIG. 1, a lane departure warning controller 116 may be in communication with DIU 200 via vehicle communications bus 102. A lane position sensor 118 may be in communication with lane departure warning controller 116. Lane position sensor 118 is generally operable to detect a position of vehicle 101 relative to a lane in which vehicle 101 is traveling.

Any other known vehicle systems that monitor operating conditions or systems of vehicle 101 may be integrated with DIU 200. For example, as shown in FIG. 1, a vehicle component monitoring system controller 120 may be provided for monitoring health of known vehicle components or subsystems. Vehicle component monitoring system controller 120 may be linked with DIU 200 via vehicle communications bus 102. Any other known vehicle components or subsystems may be linked with vehicle component monitoring system controller 120, to allow vehicle component monitoring system controller 120 to generally monitor the health of those components or subsystems. For example, as shown in FIG. 1, a tire pressure monitor 122, an airbag system monitor 124, and a coolant temperature monitor 126 may be linked with vehicle component monitoring system controller 120. Each of tire pressure monitor 122, airbag monitor 124, and coolant temperature monitor 126 preferably communicates periodically with vehicle component monitoring system controller 120, providing updates not only about conditions that may be detected by the monitors 122, 124, 126, but also operating conditions of each of the monitors 122, 124, 126. For example, tire pressure monitor 122 may transmit information to vehicle component monitoring system controller 120, indicating tire pressure readings of one or more tires (not shown) of vehicle 101, as well as any existing system faults of tire pressure monitor 122, e.g., a tire pressure sensor (not shown) in communication with tire pressure monitor 122 has lost power or is otherwise not functioning properly. A wide variety of other known systems not specifically enumerated herein are contemplated for use with system 100, such as an oil pressure monitor, windshield washer fluid level monitor, fuel level monitor, etc. Preferably, system 100 includes most or all subsystems of a vehicle that provide alerts, warning, indicators, or other information to a vehicle operator, such that the various types of information generated by the plurality of systems is integrated into a single system, e.g., DIU 200.

As briefly described above, DIU 200 is generally operable to receive indicators, e.g., warnings, alerts, messages, or other information from a plurality of vehicle subsystems and present the information to the driver in the form of various types of indicators. DIU 200 may further include hardware and/or software for determining a relative priority between two or more indicators, messages, warnings, etc., that have been received from vehicle subsystems according to a predetermined priority scheme. As will be described in further detail below, priority schemes may be customized for specific vehicle applications.

Turning now to FIG. 2, DIU 200 is shown in further detail, according to an exemplary approach. DIU 200 may include a primary display 202 for displaying visual indicators such as text, icons, lights, etc., to a vehicle operator, as may be convenient. Primary display 202 may be any known electronic display that is convenient for displaying text, icons, lights, or other visual indicators to a vehicle operator. In one illustration, primary display 202 is a backlit black-and-white liquid crystal display (LCD) having a resolution of 128×48 pixels. Other examples may employ color displays. As shown in FIG. 2, primary display 202 may be capable of displaying any combination of text messages, icons, or any other display objects for visually indicating information received from vehicle systems, and relative urgency or importance of such information. Accordingly, display 202 may indicate an importance of the message, e.g., a priority or urgency, by displaying smaller/larger text messages, icons indicating lesser/greater urgency, etc. Primary display 202 may alternatively or additionally include standardized international symbols for indicating a presence of various types of vehicle conditions. As shown in FIG. 2, primary display 202 may employ icons showing a relative position or interval between vehicle 101 and other objects, e.g., vehicles in front of or behind vehicle 101, detected by DIU 200.

DIU 200 may further include a plurality of indicator lights, displays, and external or internal speakers for relaying visual and audible indicators received from vehicle subsystems. For example, DIU 200 may include an urgent warning indicator light 204, a plurality of intermediate warning indicators lights 206a, 206b, 206c (collectively, 206), and any other lights or displays convenient for relaying indicators to a vehicle operator. Urgent warning indicator 204 may be a relatively large or bright-colored light for signaling the presence of indicators that require the vehicle operator's immediate attention. In one exemplary approach, urgent warning indicator 204 includes a red light bar extending along an upper portion of DIU 200, as shown in FIG. 2. One or more intermediate warning indicators 206 may be used to display indicators having an importance or priority that is less than that of indicators displayed with urgent warning indicator 204. For example, as shown in FIG. 2, intermediate warning indicators 206a, 206b, 206c may be a plurality of distinct yellow light bars having increasing lengths, such that an increasing/decreasing level of importance, priority, or other relative quality (e.g., a distance measured by radar 106 in regard to collision warning alerts) may be indicated by activating more/fewer of the intermediate warning indicators 206, respectively. In one example, activation of intermediate warning indicators 206a, 206b, 206c in sequence indicate decreasing following intervals between vehicle 101 and a vehicle traveling in front of vehicle 101. Alternatively, intermediate warning indicators 206a, 206b, 206c may include different colored lights to indicate increasing levels of urgency or importance, e.g., intermediate warning indicators 206a, 206b may be yellow while intermediate warning indicator 206c is orange. Different colored lights available on DIU 200 may indicate urgency or priority according to a color priority scheme, where certain colors represent more urgent or important conditions, e.g., a red light indicates a most serious or urgent condition, while yellow or green lights indicate less urgent conditions. In some exemplary approaches, the various indicators may be incorporated directly into and form a portion of primary display 202. DIU 200 may further include an internal speaker 216 for playing audible alerts or warnings for a vehicle operator. DIU 200 may also provide mounting jacks and/or outputs for connection with larger external speakers, such as those typically provided in a vehicle audio system. Any other types of known lights, displays, or speakers may be employed as convenient to indicate a presence and/or type of alerts, indicators, or warnings associated with known vehicle subsystems to a vehicle operator. DIU 200 may also allow for other types of indicators, e.g., tactile feedback through a steering wheel (not shown), brake pedal (not shown), accelerator pedal (not shown), seat (not shown) or other control mechanism of vehicle 101. For example, DIU 200 may be linked with such tactile feedback mechanisms in order to activate tactile feedback mechanisms as an indicator, in addition or as an alternative to other indicator types.

DIU 200 may further include any known hardware and software components for generally operating and using DIU 200. For example, a plurality of switches, displays, user interfaces, etc., may be provided for turning DIU 200 on and off, selecting features, increasing or decreasing various control settings of DIU 200, etc. As shown in FIG. 2, a plurality of buttons 210a, 210b, 210c (collectively, 210) may be provided for navigating menu screens of DIU 200. Any other known user interface, such as a touch screen or keypad, may be employed. DIU 200 may also include an ambient light sensor 212 disposed on the outside of DIU 200 for detecting a presence or amount of ambient light around DIU 200. Ambient light sensor 212 may thus allow for automatic dimming of display screens or warning lights of DIU 200, e.g., during nighttime driving. DIU 200 may further include a volume adjuster 214 for increasing or decreasing baseline volume levels of audible alerts or warnings which can be heard by a vehicle operator over speaker 216. Alternatively, volume may be adjusted via a menu screen using buttons 210a, 210b, 210c.

DIU 200 may additionally include a microprocessor (not shown) for supporting various operations of DIU 200 described herein, such as determining a priority of two or more indicators received by DIU 200 from vehicle subsystems, modifying indicators, etc. In one exemplary illustration, a FreeScale 9S12 processor is utilized having at least a 128K flash memory. The microprocessor is preferably connectable to communications bus 102 in any known manner, such as with a six-pin dual-row connector, a Controller Area Network (CAN) 2.0B link, etc. Any microprocessor may be employed that is convenient.

A microprocessor of DIU 200 may further support other features of DIU 200 typical of automotive system applications. For example, DIU 200 may employ a variety of menus for selecting various options, features, etc., to facilitate operation of DIU 200. Additionally, DIU 200 may include a “sleep” mode, wherein all displays and speaker outputs of DIU 200 are deactivated with the exception of a small or otherwise minimally intrusive light indicating that DIU 200 is active, until such time, for example, that DIU 200 receives a communication from a vehicle system indicating a vehicle condition. DIU 200 may further include a demonstration mode, which displays each of the various indicator lights, displays, tactile feedback mechanisms, sounds, and the like, associated with conditions of each vehicle system to familiarize a vehicle operator with the general operation of DIU 200. DIU 200 preferably also includes an accident reconstruction “freeze” feature, which retains a predetermined period of activity in a memory of DIU 200 for retrieval during investigation of traffic incidents, e.g., a crash involving vehicle 101.

Each of the various controllers described herein, including CW/ACC controller 104, lane departure warning controller 116, vehicle component monitoring system controller 120, and any microprocessor provided as part of DIU 200, may include a microprocessor, memory, or software otherwise provided or embedded within other processors or electronic systems of vehicle 101, such as, for example, DIU 200, ECM 110, or in any other known forms. Each of the controllers 104, 114, 120, and any controller or microprocessor of DIU 200 in various examples may include instructions executable by one or more computing devices of vehicle 101. Such instructions may be compiled or interpreted from computer programs created using a variety of known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

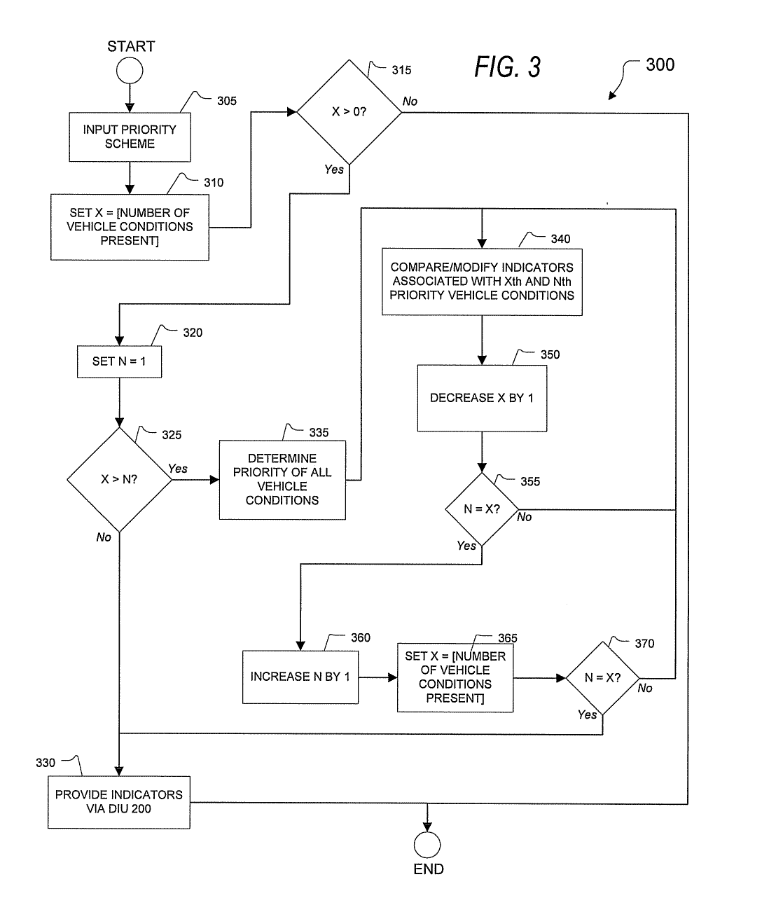

Turning now to FIG. 3, an exemplary process 300 is illustrated for displaying one or more indicators, e.g., alerts, warnings, or other information associated with one or more vehicle subsystems, to a vehicle operator. Indicators may take the form of various lights, sounds, text messages, icons, tactile feedback, etc., as described herein or otherwise generally known. Process 300 may begin at step 305, wherein a vehicle condition and indicator priority scheme is input into DIU 200. A vehicle condition and indicator priority scheme may generally define a hierarchy of conditions that may be received from different vehicle systems, and indicators associated with each condition. The priority scheme preferably ranks or categorizes each of the vehicle conditions according to an importance or urgency generally associated with the vehicle condition. More specifically, an indicator priority scheme may generally associate one or more visual, audible, or tactile indicators with each alert, warning, message, or other information generated by one or more vehicle subsystems. For example, warnings received from certain vehicle systems may be given a higher priority than warnings received from other vehicle systems that may not generally require immediate intervention vehicle operator. Accordingly, more important or urgent warnings may typically, though not always, be associated with indicators that are more intrusive, e.g., louder, larger, brighter, etc., while less important warnings may be associated with indicators that are less intrusive, e.g., softer, smaller, etc.

Indicator priority schemes may be developed for a wide variety of vehicle applications, and therefore may take into account general characteristics of a particular vehicle application in prioritizing vehicle conditions. For example, a heavy duty truck which is operated almost exclusively on interstate highways may require more urgent warnings for certain vehicle subsystems, e.g., lane departure warnings, than a military vehicle that is not often operated on interstate highways or roads with defined travel lanes. As another example, a typical passenger car having two wheels on each axle of the vehicle may require more urgent notification of a tire that is losing air pressure than a heavy duty truck having several tires on each side of its axles. In sum, a wide variety of priority schemes may be developed for the wide variety of known vehicles, wherein each priority scheme takes into account particular characteristics of a given vehicle, owner, operator, etc.

Further, each priority scheme may also take into account the particular vehicle subsystems that are provided on a given vehicle. For example, a priority scheme for a vehicle preferably includes indicators only for those systems with which the vehicle is equipped. Finally, a priority scheme for a vehicle preferably allows customization or alteration by a vehicle manufacturer, owner, or operator, preferably with DIU 200 using any of the various user interfaces, buttons, etc., described herein or otherwise known. Accordingly, a priority scheme may be input to DIU 200 in step 305 that is generally customizable for any known vehicles, applications, or driver or manufacturer preferences.

An exemplary illustration of an indicator priority scheme will now be described in further detail to illustrate general operating rules or principles that may be useful for developing a priority scheme for a heavy-duty vehicle application. A wide variety of alterations and modifications not specifically described herein may be desirable for a given vehicle application. Further, other known vehicle subsystems not specifically described herein may be included in such other priority schemes.

An example of one possible priority scheme may include a plurality of baseline indicators for all relevant vehicle conditions that may be communicated to an operator of vehicle 101. For example, Table 1 lists nineteen (19) conditions that may be detected by systems of vehicle 101 described above, as well as a brief description of the condition. Other examples of a vehicle condition and indicator priority scheme may employ different characteristics or thresholds to determine the applicability of a given condition. For each condition, indicators associated with the specific condition may be displayed or played via the lights 204, 206, display 202, and speaker 216 of DIU 200, as noted in Table 1:

TABLE 1
Vehicle Condition and Indicator Priority Scheme

| Vehicle | | | | Associated Indicators | | |
|---|---|---|---|---|---|---|
| Condition | | Vehicle | | Warning | | |
| Priority | System | Condition | Description | Light(s) | Sound | Text/Icon |
| 1 | Lane | Continuing | Vehicle continuing | Intermediate | Repeated | Medium- |
| | Departure | Drifting | drifting out of lane on | (206a, 206b, | beep | size font |
| | Warning | Left/Right | left/right hand side | 206c) | played on | |
| | | | | | left/right | |
| | | | | | hand side | |
| | | | | | speakers | |
| | | | | | only | |
| | | | | | (Max. | |
| | | | | | Volume) | |
| 2 | Lane | Drifting | Vehicle slowly drifting | Intermediate | Single | Medium- |
| | Departure | Left/Right | out of lane on left/right | (206a, 206b) | beep | size font |
| | Warning | | hand side | | played on | |
| | | | | | left/right | |
| | | | | | hand side | |
| | | | | | speakers | |
| | | | | | only | |
| | | | | | (Max. | |
| | | | | | Volume) | |
| 3 | Collision | 0.5 second | Target in same lane, | Intermediate | Repeated | Large- |
| | Warning/ACC | interval | following interval less | (206a, 206b, | beeping | size font |
| | | | than 0.5 seconds | 206c) and | (Normal | and/or |
| | | | (increasing or | Urgent (204) | Volume) | object in |
| | | | decreasing), host | | | front of |
| | | | vehicle speed is greater | | | host |
| | | | than 10 mph | | | vehicle |
| | | | | | | icon |
| 4 | Collision | Slow | Target in same lane, | Intermediate | Double | Large- |
| | Warning/ACC | moving | following interval less | (206a, 206b, | beep | size font |
| | | target | than 3 seconds, target | 206c) and | (Normal | and/or |
| | | detected | range less than 220 feet | Urgent (204) | Volume) | object in |
| | | | or desired following | | | front of |
| | | | distance (whichever is | | | host |
| | | | smaller), host vehicle | | | vehicle |
| | | | speed greater than 35 mph, | | | icon |
| | | | host vehicle | | | |
| | | | speed is at least 25% | | | |
| | | | greater than target | | | |
| | | | velocity | | | |
| 5 | Collision | Stationary | Target speed at or near | Intermediate | Double | Large- |
| | Warning/ACC | target | 0 mph, in same lane, | (206a, 206b, | beep | size font |
| | | detected | target range less than | 206c) and | (Normal | and/or |
| | | | 220 feet or desired | Urgent (204) | Volume) | object in |
| | | | following distance | | | front of |
| | | | (whichever is smaller), | | | host |
| | | | host vehicle speed | | | vehicle |
| | | | greater than 10 mph | | | icon |
| 6 | Collision | 1 second | Vehicle speed greater | Intermediate | Double | Large- |
| | Warning/ACC | interval, | than 10 mph, target in | (206a, 206b, | beep | size font |
| | | decreasing | same lane, following | 206c) and | (Normal | and/or |
| | | | interval less than 1 | Urgent (204) | Volume) | object in |
| | | | second, target distance | | | front of |
| | | | less than desired | | | host |
| | | | following distance, | | | vehicle |
| | | | target velocity less than | | | icon |
| | | | 105% of host vehicle | | | |
| | | | speed | | | |
| 7 | Collision | 1 second | Vehicle speed greater | Intermediate | None | Large- |
| | Warning/ACC | interval, | than 10 mph, target in | (206a, 206b, | | size font |
| | | increasing | same lane, following | 206c) and | | and/or |
| | | | interval less than 1 | Urgent (204) | | object in |
| | | | second and increasing, | | | front of |
| | | | target distance less than | | | host |
| | | | desired following | | | vehicle |
| | | | distance, target velocity | | | icon |
| | | | greater than 105% of | | | |
| | | | host vehicle speed | | | |
| 8 | Tire Pressure | Blowout | Sudden or rapid loss of | Intermediate | Single | Medium |
| | Monitoring | | pressure detected in a | (206a, 206b) | beep on | font |
| | System | | tire | | side | and/or |
| | | | | | where | Tire |
| | | | | | pressure | Pressure |
| | | | | | low | icon |
| | | | | | detected | |
| | | | | | (Normal | |
| | | | | | Volume) | |
| 9 | Collision | 2 second | Vehicle speed greater | Intermediate | Single | Medium- |
| | Warning/ACC | interval, | than 10 mph, target in | (206a, 206b) | beep | size font |
| | | decreasing | same lane, following | | (Normal | and/or |
| | | | interval 1-2 seconds, | | Volume) | object in |
| | | | target distance less than | | | front of |
| | | | desired following | | | host |
| | | | distance, target velocity | | | vehicle |
| | | | less than 101% of host | | | icon |
| | | | vehicle speed | | | |
| 10 | Collision | 2 second | Vehicle speed greater | Intermediate | None | Medium- |
| | Warning/ACC | interval, | than 10 mph, target in | (206a, 206b) | | size font |
| | | increasing | same lane, following | | | and/or |
| | | | interval 1-2 seconds, | | | object in |
| | | | target distance less than | | | front of |
| | | | desired following | | | host |
| | | | distance, target velocity | | | vehicle |
| | | | greater than 101% of | | | icon |
| | | | host vehicle speed | | | |
| 11 | Collision | 2-3 second | Vehicle speed greater | Intermediate | None | Medium- |
| | Warning/ACC | interval | than 10 mph, target in | (206a) | | size font |
| | | | same lane, following | | | and/or |
| | | | interval 2-3 seconds | | | object in |
| | | | (increasing or | | | front of |
| | | | decreasing), target | | | host |
| | | | distance less than | | | vehicle |
| | | | desired following | | | icon |
| | | | distance | | | |
| 12 | Vehicle | Coolant | Coolant temperature | Intermediate | Single | Medium |
| | Component | Temperature | near overheat | (206a, 206b, | beep | font |
| | Monitoring | Near Hot | temperature | 206c) | (Reduced | |
| | System | | | | Volume) | |
| 13 | Collision | Creep | Target less than 15 feet | Intermediate | Double | Small- |
| | Warning/ACC | | in front of vehicle, | (206a) | beep | size font |
| | | | vehicle speed less than | | (Normal | and/or |
| | | | 2 mph, closing speed | | Volume) | object in |
| | | | less than 0.5 mph | | | front of |
| | | | | | | host |
| | | | | | | vehicle |
| | | | | | | icon |
| 14 | Collision | Detect | Target detected in front | Intermediate | None | Small- |
| | Warning/ACC | | of vehicle | (206a) | | size font |
| | | | | | | and/or |
| | | | | | | object in |
| | | | | | | front of |
| | | | | | | host |
| | | | | | | vehicle |
| | | | | | | icon |
| 15 | Lane | Vehicle | Vehicle detected on | Intermediate | None | Small- |
| | Departure | Detected | side of host vehicle | (206a) | | size font |
| | Warning | | (e.g., in blind spot) | | | |
| 16 | Tire Pressure | Slow leak | Low pressure | None | None | Small- |
| | Monitoring | | (gradually decreasing) | | | size font |
| | System | | detected in a tire | | | and/or |
| | | | | | | Tire |
| | | | | | | Pressure |
| | | | | | | icon |
| 17 | Collision | System | Radar or other | Intermediate | None | Small- |
| | Warning/ACC | Malfunction | component damaged or | (206a) | | size font |
| | | | inoperable | | | |
| 18 | Vehicle | Airbag | Airbag sensor not | Intermediate | None | Small- |
| | Component | malfunction | communicating | (206a) | | size font |
| | Monitoring | | properly or lost signal | | | |
| | System | | | | | |
| 19 | Vehicle | Tire | Tire pressure gauge not | Intermediate | None | Small- |
| | Component | pressure | communicating | (206a) | | size font |
| | Monitoring | gauge | properly or lost signal | | | and/or |
| | System | malfunction | | | | Tire |
| | | | | | | Pressure |
| | | | | | | icon |

In addition to the various lights and sounds listed for each vehicle condition in Table 1, a descriptive message may be associated with each condition. Descriptive messages may be displayed on DIU 200 within primary display 202, e.g., as large font messages, medium font messages, or small font messages, or icons as indicated or otherwise convenient. Further, any other known indicators may be employed as part of an indicator priority scheme, e.g., tactile feedback indicators, icons displayed on any display area of DIU 200, etc.

As shown in Table 1, each vehicle condition that may be detected by vehicle 101 is associated with a priority or rank to generally organize vehicle conditions in relation to each other. Accordingly, each of the various conditions is ranked from one (1) through nineteen (19), where lower numbers may indicate conditions having indicators that preferably are not modified, e.g., conditions that are generally more serious or urgent. Higher ranked conditions may be associated with indicators that tend to indicate a more serious or urgent condition by being more intrusive, e.g., including brighter, louder, or larger indicators. This ranking may be employed to determine which indicators may be modified when multiple vehicle conditions are present at a given time that may cause confusion or overlap, as described below. Any other conditions desirably included as part of the operation of the systems of vehicle 101 specifically described herein, or other known systems not specifically described, may be included in various exemplary approaches for a vehicle condition indicator priority scheme. Further, each of the various conditions may be ranked differently, according to particular characteristics of a specific vehicle application. Accordingly, a vehicle condition indicator priority scheme may have a smaller or greater number of vehicle conditions that are integrated into the scheme, and further may employ different strategies for ranking vehicle conditions, and associated indicators.

According to the priority scheme illustrated in Table 1, indicators associated with a collision warning subsystem or lane departure warning subsystem may generally have a higher priority than other vehicle subsystems, especially in regard to imminent collisions with other vehicles. Therefore, indicators designed to notify a vehicle operator of imminent dangerous collision conditions, e.g., a following distance between vehicle 101 and a vehicle detected by radar 106 is less than 0.5 seconds, and vehicle 101 is traveling faster than 10 miles per hour, are generally not modified, while indicators associated with lower priority alerts, e.g., a low pressure condition is detected in one tire of vehicle 101, may be modified to the extent that providing the tire low pressure warning at the same time as the collision warning would be confusing for the vehicle operator. Accordingly, higher priority alerts are generally not altered, since they are more serious than other alerts. Lower priority alerts may be altered in any way convenient that generally allows the lower priority alert to be displayed at the same time as the higher priority indicator, such that a vehicle operator may perceive each indicator separately, and also understand the information implicit in each indicator without confusion. Generally, lower priority indicators may be converted to less intrusive indicators. Merely by way of example, sound associated with a lower priority indicator may be reduced or eliminated where it is redundant with sound associated with a higher priority indicator, or a size of a warning message displayed on primary display 202 may be reduced or displayed as a small icon instead of text.

Accordingly, all indicators that may be employed by DIU 200 as part of a predetermined priority scheme to notify a vehicle operator of the presence of vehicle conditions may be ranked according to a level of intrusiveness to the vehicle operator. In one illustrative example, the ranking of indicators according to intrusiveness described above is employed to modify indicators when indicators associated with generally higher priority vehicle conditions exist, as described below. After DIU 200 receives a priority scheme in step 305, process 300 may proceed to step 310.

In step 310, DIU 200 may detect or otherwise determine a number of vehicle conditions currently present. For example, DIU 200 may receive a communication from CW/ACC controller 104, e.g., a J1939 message, indicating an unsafe following distance condition, and a second communication from vehicle component monitoring system controller 120 associated with a tire low pressure condition. In the example, DIU 200 would determine that two vehicle conditions have been detected, and store the integer two (2) in a vehicle condition counting variable, “X.” Process 300 may then proceed to step 315.

In step 315, DIU 200 may query whether the variable X stored in step 310 is greater than zero, i.e., whether any vehicle conditions have been detected. If X equals zero, no vehicle conditions requiring activation of any indicators exist and process 300 may terminate. Alternatively, process 300 may return to any earlier step of process 300, e.g., step 310, such that process 300 generally runs continuously, detecting a presence of vehicle conditions generally constantly while vehicle 101 is in operation. If X is greater than zero, i.e., at least one vehicle condition is present necessitating activation of an associated indicator, process 300 may proceed to step 320.

In step 320, a counting variable, “N,” may be set to the integer one (1). Counting variable N may be incremented and decremented, such that vehicle conditions and associated indicators are counted and modified sequentially, as will be described further below. Process 300 may then proceed to step 325.

In step 325, DIU 200 may query whether X is greater than N, i.e., whether more than one vehicle condition has been detected by DIU 200, e.g., more than one J1939 message has been received from a vehicle system. If X is not greater than N, i.e., only one vehicle condition is present, process 300 may proceed to step 330, where all indicators associated with the vehicle condition are displayed or otherwise made available for perception by a vehicle operator, e.g., played over speaker 216 of DIU 200. Accordingly, where only one vehicle condition is present, indicators associated with the vehicle condition, e.g., indicators illustrated in Table 1 above, may generally be provided via DIU 200 in unmodified form. If X is greater than N, i.e., more than one indicator is present, process 300 may proceed to steps 335 through 370.

Steps 335 through 370 may be provided as part of process 300 to generally rank and compare each of the vehicle conditions that are present, and determine whether any of the indicators associated with the vehicle conditions should be modified in order to clearly display all of the indicators generally simultaneously. In step 335 each indicator detected in step 310 may be generally ranked according to a relative priority in comparison with the other indicators detected in step 310. For example, all indicators detected in step 310 may be ranked in order of importance or urgency to the vehicle operator, in accordance with general principles outlined above regarding the relative importance of the various indicators, or any other ranking or priority scheme that may be convenient. For example, a priority scheme input at step 305 may be used in determining a relative priority of any indicators present. Process 300 may then proceed to step 340.

In steps 340 through 370, indicators associated with each vehicle condition detected in step 310 are generally compared with indicators associated with other vehicle conditions also detected in step 310 to generally determine whether any of the indicators should be modified to improve the presentation of all indicators simultaneously. For example, steps 340 through 370 may be used to determine whether two or more indicators interfere or “overlap” with each other. Indicators may be said to “overlap” where two indicators employ identical or very similar visual, audible, or other type indicators, thereby making perception of each indicator difficult or time-consuming for a vehicle operator. For example, indicators associated with an urgent collision warning and with a rapid loss of tire pressure, i.e., a tire blowout, may each include activating a large font text warning displayed on DIU 200. Accordingly, steps 340 through 370 may determine when one or more indicators overlap with another indicator present, and modify at least one of the indicators such that all indicators may be displayed generally simultaneously without withholding any of the indicators or confusing a vehicle operator.

In step 340, DIU 200 may compare each indicator associated with an “Nth” priority vehicle condition and an “Xth” priority vehicle condition, and modify indicators where they may tend to cause confusion or are otherwise may not be easily understood by a vehicle operator when presented simultaneously via DIU 200. For example, where three vehicle conditions are detected in step 310, DIU 200 may compare all indicators associated with the 1^{st} priority vehicle condition (N initially is set to the integer one) with the indicators associated with the 3^{rd} priority vehicle condition (X initially is set to the total number of vehicle conditions present, three). Indicators associated with the 3^{rd} priority vehicle condition may generally be modified in any way to allow all indicators to be displayed to effectively communicate every condition that is present at a given time such that a vehicle operator may comprehend each condition that is present. While step 340 is described herein as comparing a single pair of indicators, step 340 may generally operate to examine every pair of indicators associated with the Nth and Xth priority vehicle conditions. More specifically, step 340 may generally compare every indicator associated with the Nth priority vehicle condition with the Xth priority vehicle condition.

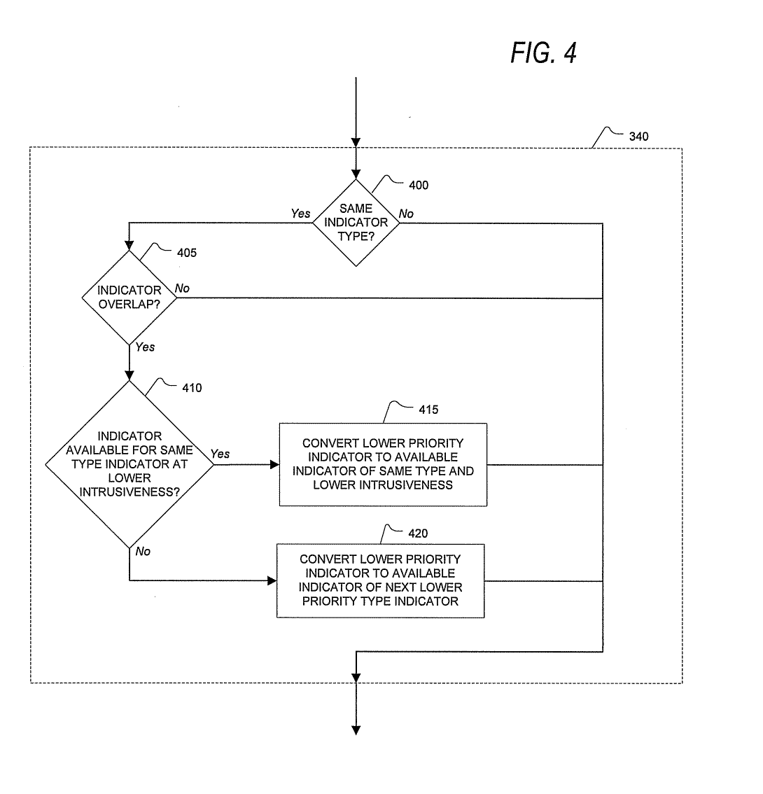

For example, turning now to FIG. 4, one exemplary illustration of step 340 is shown. As shown in FIG. 4, step 340 may include sub-steps 400, 405, 410, and 415, wherein each indicator associated with the Xth priority vehicle condition detected in step 310 is compared with each indicator associated with the Nth priority vehicle condition. Other steps or methodologies may be included as part of step 340 in place of or in addition to the steps illustrated in FIG. 4 to generally compare and, if necessary, modify indicators associated with vehicle conditions present generally at the same time. In step 400, an indicator associated with the Xth priority vehicle condition is compared with an indicator associated with the Nth priority vehicle condition to determine whether the two indicators are of a same type, e.g., both indicators are audible sounds, lights, text message displays, or tactile feedback. If the indicators are each different types, no modification of indicators will generally be necessary, since each indicator will tend to be easily comprehended separately by the vehicle operator. For example, a vehicle operator will typically be able to comprehend the presence of an audible indicator and a tactile feedback indicator at the same time, since the vehicle operator may hear the audible indicator and feel the tactile feedback indicator independently of one another. Accordingly, where a pair of indicators being compared is of different general types, process 300 may proceed to step 350.

If a pair of indicators compared in step 400 are determined to be of a same general type, e.g., both indicators are an audible sound, the process 300 may proceed to step 405. In step 405, the indicators may be compared to determine whether an overlap exists that could potentially cause operator confusion. For example, where a first indicator is an audible beeping sound, and a second indicator is an audible beeping sound of a similar pitch, tone, volume, etc., the indicators may be said to overlap. On the other hand, where a first indicator is an audible sound of a first pitch, and the second indicator is an audible sound of a second pitch that is distinguishably higher or lower than the first pitch, then the indicators may be said to be non-overlapping. DIU 200 may be pre-programmed with guidelines or rules for determining which indicators of each same type overlap with each other. Accordingly, a threshold for determining whether indicators overlap may be altered according to manufacturer, operator, or driver preferences. If DIU 200 determines that the indicators examined in step 405 do not overlap, e.g., the indicators are easily distinguishable from each other when presented simultaneously, or do not otherwise cause confusion, process 300 may proceed to 350. If the indicators do overlap, process 300 may proceed to steps 410-420, where the overlapping indicator associated with the lower priority vehicle condition, e.g., the Xth priority condition, may be modified.

Indicators associated with lower priority vehicle conditions may be modified by generally reducing an intensity or intrusiveness associated with the indicator, preferably without eliminating the indicator entirely, as described below in steps 410 through 420. Further, indicators may be converted to other indicator types in order to reduce or eliminate overlapping between indicators. Accordingly, the reduction in intrusiveness of an overlapping or interfering indicator may generally reduce or eliminate the degree to which the indicator overlaps with another indicator.

Indicators that may be output by DIU 200 are preferably organized according to a level of intrusiveness, i.e., the degree to which each indicator is readily perceived by a vehicle operator, in order to simplify modification of indicators. Indicators may be grouped according to a general indicator type, e.g., audible, light display, text display, or tactile feedback. Each indicator type may be ordered according to its level of intrusiveness. For example, tactile feedback indicators are ranked as the most intrusive indicators, while audible indicators are the second most intrusive, visual light indicators the third most intrusive, and text message displays the least intrusive. Further, each group of indicators included in a particular type may be ordered in terms of intrusiveness relative to other indicators of the same type. Tactile feedback indicators may be ranked according to the amplitude level or duration of vibration felt as part of the tactile feedback indicator, i.e., more forceful vibrations may be ranked as more intrusive than less forceful vibrations, and vibrations having longer durations may be ranked as more intrusive than vibrations of shorter durations. Audible indicators that play a greater number of distinct sounds, louder sounds, or higher pitch sounds may be ranked as more intrusive than audible indicators having fewer distinct sounds, sounds having reduced volume, or lower pitch sounds, respectively. For example, an audible indicator that plays a number of distinct “beep” sounds at a maximum volume may be more intrusive than an audible indicator that plays a lesser number of distinct “beep” sounds, or the same number of “beep” sounds at a lower pitch or volume level. Visual light indicators may be ranked in order of intrusiveness from the brightest light displays to the dimmest. Additionally, certain color lights, e.g., red lights such as urgent warning light 204, may be ranked as the most intrusive, with other colors, e.g., yellow lights such as intermediate warning lights 206, being less intrusive. Text display indicators may be most intrusive where they include the largest text, and less intrusive where they include smaller text. Icon display indicators may be most intrusive where they indicate urgent conditions, such as when primary display 202 shows host vehicle 101 and another object very close together. Icon display indicators may be least intrusive where they illustrate less dangerous conditions, such as when primary display 202 shows host vehicle 101 alone, i.e., without any objects in close proximity. Other icons may be employed as may be convenient for illustrating various levels of urgency and/or intrusiveness. Accordingly, the indicators may be organized by intrusiveness in a table for use in steps 410 through 420 in modifying indicators that overlap with other indicators associated with higher priority vehicle conditions. One example of an indicator intrusiveness table is provided below, in Table 2:

TABLE 2
Indicator Intrusiveness Table

| | Tactile | | | |
|---|---|---|---|---|
| | Feedback | Audible | Visual | Text/Icon |
| | Indicators | Indicators | Indicators | Indicators |
| ↓ | Maximum | Loudest | Urgent (Red) | Large font |
| Intrusiveness | Vibration | Volume | and | text message |
| Decreasing | | | Intermediate | and/or High |
| ↓ | | | (Yellow) | Urgency icon |
| | | | Warning | |
| | | | Lights | |
| | Normal | Normal | Intermediate | Medium font |
| | Vibration | Volume | (Yellow) | text message |
| | | | Warning | and/or |
| | | | Lights | Normal |
| | | | | Urgency icon |
| | Reduced | Reduced | No indicator | Reduced font |
| | Vibration | Volume | light | text message |
| | | | | and/or |
| | | | | Reduced |
| | | | | Urgency icon |

→ Intrusiveness Decreasing →

Indicators shown in Table 2 are generally ordered from most intrusive type in the upper left-hand corner to the least intrusive type in the lower right-hand corner.

In step 410, it may be determined whether an alternative indicator of the same type is available having a lower level of intrusiveness. For example, where an audible indicator has been determined to overlap with another audible indicator, step 410 may query whether another audible indicator is available. Step 410 may thus determine whether another indicator which is less intrusive and therefore less likely to cause confusion by its presence is available, e.g., not currently associated with a vehicle condition that is present as determined in step 310. Where a less intrusive indicator of the same type as the overlapping indicator is present, process 300 may proceed to step 415, where the overlapping indicator may be converted to the available less intrusive indicator of the same type. Where a less intrusive indicator of the same type as the overlapping indicator is not available, e.g., all less intrusive indicators of the same type are already present as a result of other vehicle conditions detected in step 310, or the overlapping indicator currently being modified is the least intrusive indicator of its indicator type, process 300 may proceed to step 420. In step 420, the overlapping indicator may be converted to the most intrusive indicator available for the next most intrusive indicator type. For example, where the overlapping indicator is a tactile feedback indicator, and no less intrusive tactile feedback indicators are available, the overlapping indicator may be converted to the most intrusive audible indicator that is present, e.g., a loud beeping sound. Process 300 may then proceed to step 350.

Steps 350 through 370 generally operate such that indicators associated with each of the vehicle conditions detected in step 310 are compared with all other indicators associated with lower priority vehicle conditions in sequence. Accordingly, DIU 200 generally applies step 340 to each vehicle condition, and every associated indicator having a lower-priority, in turn. The X and N variables described above are decreased and increased after interferences between indicators are tested for each pair of vehicle conditions in step 340. Accordingly, DIU 200 may determine whether interferences exist between the indicators associated with each vehicle condition detected in step 310. Other exemplary illustrations may employ different methods or processes for comparing indicators associated with each vehicle condition detected in step 310. Further, process 300 need not compare the indicators for each and every vehicle condition that is detected. For example, according to some exemplary illustrations it may be preferable to compare only the indicators associated with the highest and lowest priority vehicle conditions, to generally simplify process 300.

In step 350, the variable X is decreased by one. Process 300 then proceeds to step 355, where DIU 200 determines whether the variable N is now equal to the variable X. If N is not equal to X, process 300 proceeds back to step 340; if N is equal to X then process 300 proceeds to step 360. In step 360, the variable N is increased by one. Process 300 then proceeds to step 365, where X is reset to the original number of vehicle conditions detected in step 310. Process 300 then proceeds to step 370, where DIU 200 queries whether N is now equal to X. If N is not equal to X, process 300 proceeds back to step 340. If N is equal to X, process 300 proceeds to step 330, where all indicators are displayed or played over DIU 200.

An illustrative example of the operation of steps 340 through 370 will now be described, where three vehicle conditions are detected in step 310. Accordingly, X is initially set to the integer three (step 310), while N is initially set to the integer one (step 320). Therefore, in step 340, DIU 200 may compare the indicators associated with the 1^{st} and 3^{rd} priority vehicle conditions. Any indicators associated with the 3^{rd} priority vehicle condition may be modified in steps 400 through 420 as described above to generally prevent overlapping indicators associated with the 3^{rd} priority vehicle condition from interfering with indicators of the 1^{st} priority condition, thereby improving perception of the various indicators when they are provided simultaneously. The variable X is then decreased by one in step 350, from the integer three to the integer two. Since N is still the integer one, step 355 returns process 300 to step 340. In step 340, since X has been reduced to the integer two, DIU 200 compares the indicators associated with the 1^{st} and 2^{nd} priority vehicle conditions and modifies indicators associated with the 2^{nd} priority vehicle condition according to steps 400 through 420. The variable X is then reduced again, from the integer two to the integer one, in step 350. Process 300 thus proceeds to step 360, since N and X are equal. In step 360, the variable N is increased from one to two. In step 365, the variable X is reset to the number of vehicle conditions detected in step 310, three. Accordingly, process 300 proceeds back to step 340, where DIU 200 compares the indicators associated with the 2^{nd} and 3^{rd} priority vehicle conditions. As determined in steps 400 through 420, indicators associated with the 3^{rd} priority vehicle condition are modified where they may overlap with indicators associated with the 2^{nd} priority vehicle condition. In step 350, the variable X is increased by one, such that the variables X and N are both equal to the integer two. Accordingly, process 300 proceeds to step 360, where N is increased by one, and further to step 365, where X is reset to the initial number of vehicle conditions detected in step 310. Accordingly, both X and N are equal to the integer three, and process 300 proceeds to step 330, where the indicator(s) associated with the 1^{st} priority vehicle conditions are output by DIU 200 in generally unmodified form, while indicators associated with each of the 2^{nd} and 3^{rd} priority vehicle conditions are output in modified form, as determined according to the operation of steps 400 through 420 on the various indicators associated with each pair of vehicle conditions.

After all indicators are displayed and/or played in step 330, process 300 may end, as shown in FIG. 3. Alternatively, process 300 may return to step 310, such that process 300 runs generally continuously during the operation of DIU 200 and/or vehicle 101, detecting, modifying and outputting indicators as vehicle conditions are detected by vehicle 101.

A further illustrative example of process 300 will now be described, including an example of how indicators may be modified. First, the vehicle condition indicator priority scheme described above in Table 1 is input into DIU 200. In this example, vehicle 101 is drifting out of its traveling lane to the right, and is also traveling at a speed greater than 10 miles per hour while following a slower moving vehicle such that the following distance between vehicle 101 and the slower moving vehicle is less than 0.5 seconds. Accordingly, DIU 200 receives a J1939 communication indicating a “0.5 Second Interval” condition from the CW/ACC controller 104, and a J1939 communication indicating a “Continuing Drifting Right” condition from the lane departure warning system controller 116. DIU 200 therefore detects two conditions in step 310, and sets the vehicle condition counting variable, X to the integer two. Process 300 therefore proceeds to step 320, as more than one vehicle condition is present. At step 325, the variable X is determined to be larger than the variable N, and process 300 proceeds to step 325. In step 335, the vehicle conditions are ranked. According to Table 1, the “Continuing Drifting Right” condition detected by the lane departure warning system is higher on the priority list, having a rank of one (1), while the “0.5 Second Interval” condition detected by the collision warning/ACC system has a rank of three (3). Accordingly, the “Continuing Drifting Right” is ranked as the 1^{st} priority vehicle condition, and the “0.5 Second Interval” is ranked as the 2^{nd} priority vehicle condition.

In step 340, the indicators associated with the 1^{st} priority condition (0.5 Second Interval) are compared with indicators associated with the 2^{nd} priority condition (Continuing Drifting Right). As listed in Table 1 above, each condition is associated with three indicators:

0.5 Second Interval Condition
(1) Visual indicator: activation of all three intermediate warning lights 206 and urgent warning light 204
(2) Audible indicator: a double beep played over external audio speakers of vehicle 101 at normal volume
(3) Text/Icon indicator: a large font text message displayed on primary display 202 and/or display icon indicating presence of an object in front of host vehicle

Continuing Drifting Right Condition
(1) Visual indicator: activation of all three intermediate warning lights 206
(2) Audible indicator: a double beep played only over the external speakers on the right hand side of vehicle 101 at maximum volume
(3) Text indicator: a medium font text message displayed on primary display 202
   Accordingly, in steps 400 through 420, the three indicators associated with the lower priority condition according to Table 1 (0.5 Second Interval condition), are compared with the three indicators associated with the higher priority condition (Continuing Drifting Right condition) to determine whether the indicators overlap and, accordingly, whether the indicators associated with the 0.5 Second Interval condition should be modified.

Step 405 generally screens indicator pairs that are not the same type from being compared in steps 405 through 420. Accordingly, DIU 200 generally may compare indicator pairs of the same type in steps 405 through 420. Steps 405 through 420 are accordingly applied to the pair of indicators of each type listed above in turn.

The visual indicator associated with the 0.5 Second Interval condition listed above (hereinafter “first low-priority indicator”) includes the activation of all three intermediate warning lights 206 and urgent warning light 204. The visual indicator associated with the Continuing Drifting Right condition includes the activation of all three intermediate warning lights 206. In step 405, DIU 200 compares the visual indicators associated with each condition, and queries whether the indicators overlap, or would otherwise cause confusion. In this example, no confusion would occur from presenting both indicators, since the visual indicator associated with the Continuing Drifting Right includes activating lights that are also included in the visual indicator for the first low-priority condition. Accordingly, both indicators may be presented simultaneously, since there is no “overlap” between the visual indicators.

Steps 400 through 420 may be repeated for the audible indicators associated with each condition. The normal-volume double beep sound associated with the 0.5 Second Interval condition may mask the maximum-volume double beep sound associated with the Continuing Drifting Right condition to at least some extent, since the Continuing Drifting Right condition only provides the audible indicator on the right-hand side speakers of vehicle 101, and a similar sound emanating from the left-hand side speakers may reduce the driver's ability to distinguish the sound coming solely from the right-hand side speakers. Accordingly, DIU 200 identifies an overlap between the two indicators in step 405. Therefore, in steps 410-420, the overlapping double-beep indicator of the lower priority condition, the 0.5 Second Interval, may be modified. In step 410, DIU 200 queries whether a lower priority indicator is available of the same type (audible) as the overlapping indicator. Here, a lower priority audible indicator is present in the hierarchy of indicator intrusiveness provided in Table 2, above. Accordingly, the overlapping indicator may be modified by decreasing the intrusiveness of the audible indicator one step. Therefore the audible indicator associated with the 0.5 Second Interval condition is modified by decreasing the volume of the indicator. In other examples, the volume of the audible indicator may be removed entirely, or changed in pitch or tone to reflect the decreased intrusiveness to the vehicle operator. Accordingly, when the indicators are provided in step 330, below, the emphasis on the indicator provided over the right-hand side speakers is made evident to the vehicle operator in the form of the reduced volume indicator provided on the left-hand side speakers. Accordingly, an operator may perceive the right-hand side indicator associated with the Continuing Drifting Right condition more easily, thereby reducing confusion as a result of the presence of the indicators associated with the 0.5 Second Interval condition.

Steps 400 through 420 may be repeated for the text/icon indicators associated with each condition. Step 405 preferably identifies no overlap for the text message indicators associated with the 0.5 Second Interval and Continuing Drift Right conditions, since each indicator is sized differently, and an icon is only presented for the 0.5 Second Interval condition. Accordingly, both text/icon indicators can be provided simultaneously on primary display 202 of DIU 200, generally without confusion. As an alternative, each text/icon indicator may be displayed sequentially, i.e., one immediately after the other, to generally simultaneously indicate the presence of both indicators. After examining each indicator pair, process 300 may proceed to step 350.

In step 350, the variable X is decreased by one (1), reducing the variable X from the integer two (2) to the integer one (1). In step 355, the variables X and N are equal, and process 300 proceeds to step 360. In steps 360 and 365, the variables N and X are set to the integer two (2), respectively, by increasing the variable N by one (1) and resetting the variable X to the initial number of vehicle conditions detected. Accordingly, process 300 proceeds to step 330, where the indicators of each vehicle condition are displayed, including the modified indicators. As a result of modifying the sound indicator associated with the 0.5 Second Interval condition, the indicators provided generally simultaneously over DIU 200 include:
Activation of all three intermediate warning lights 206 and urgent warning light 204
Display of a large font text message and/or an icon illustrating host vehicle 101 in close proximity to a vehicle traveling in front of host vehicle 101, indicating the 0.5 Second Interval condition
Display of a medium font text message indicating the Continuing Drifting Right condition (may be displayed simultaneously or in sequence with large font text/icon for 0.5 Second Interval condition)
Playing of the Continuing Drifting Right indicator sound over the external speakers on the right-hand side of vehicle 101
Playing of the 0.5 Second Interval indicator sound over the external speakers on both the right and left-hand sides of vehicle 101 at a reduced volume
   Accordingly, both the 0.5 Second Interval condition and the Continuing Drifting Right condition are made evident to a vehicle operator in a manner that generally minimizes confusion caused by the presence of multiple vehicle conditions and associated indicators at once.

DIU 200 and process 300 thus generally operate to detect informative indicators associated with vehicle conditions detected by a plurality of vehicle subsystems, and modify lower priority indicators such that information implicit in each indicator is readily perceived and understood by a vehicle operator. Indicators are therefore generally not suppressed, such that information is not lost, and yet the great deal of information provided where multiple indicators exist generally will not overwhelm or confuse a vehicle operator.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain approaches, examples or embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising:
a first input indicating a first vehicle condition, said first condition associated with a first indicator;
a second input indicating a second vehicle condition, said second condition associated with a second indicator; and
a driver interface unit in communication with said first and second inputs, said driver interface unit operable to modify one of said first and second indicators according to a priority between said first and second vehicle conditions to create a modified indicator, said driver interface unit operable to output said modified indicator and the other of said first and second indicators generally simultaneously.

2. The system of claim 1, wherein said driver interface unit is operable to modify said one of said first and second indicators according to at least an intrusiveness of said one of said first and second indicators.

3. The system of claim 1, wherein said driver interface unit is operable to modify said one of said first and second indicators according to at least whether said one of said first and second indicators overlaps with said other of said first and second indicators.

4. The system of claim 1, wherein there are a plurality of different types of indicators, said driver interface unit operable to convert said one of said first and second indicators from a first type of indicator to a second type of indicator.

5. The system of claim 4, wherein said plurality of different types of indicators include an audible indicator, a visual indicator, and a tactile feedback indicator.

6. The system of claim 1, wherein said modified indicator is less intrusive than said one of said first and second indicators.

7. The system of claim 1, wherein said one of said first and second indicators is a first audible indicator, and said modified indicator is a second audible indicator, said second audible indicator being one of softer, shorter, and lower-pitched than said first audible indicator.

8. The system of claim 1, wherein said one of said first and second indicators is a first tactile feedback indicator, and said modified indicator is a second tactile feedback indicator, said second tactile feedback indicator being one of shorter and less forceful than said first tactile feedback indicator.

9. The system of claim 1, wherein said one of said first and second indicators is a first visual indicator, and said modified indicator is a second visual indicator, said first visual indicator being one of brighter and larger than said second visual indicator.

10. The system of claim 1, wherein said one of said first and second indicators is a first visual indicator, and said modified indicator is a second visual indicator, said first visual indicator including a color associated with a higher intrusiveness than a color associated with said second visual indicator.

11. The system of claim 1, wherein said one of said first and second indicators is a first text indicator, and said modified indicator is a second text indicator, said second text indicator including text that is smaller than said first text indicator.

12. The system of claim 1, wherein said one of said first and second indicators is a first visual indicator, and said modified indicator is a second visual indicator, said first visual indicator including an icon associated with a higher intrusiveness than an icon associated with said second visual indicator.

13. The system of claim 1, further comprising at least one of an adaptive cruise control system, a collision warning system, a lane departure warning system, and a vehicle component monitoring system in communication with said driver interface unit, each of said first and second inputs being received from one of said at least one of an adaptive cruise control system, a collision warning system, a lane departure warning system, and a vehicle component monitoring system.

14. The system of claim 1, further comprising a predetermined priority scheme defining a relative priority between said first and second vehicle conditions, wherein said priority between said first and second vehicle conditions is determined from said predetermined priority scheme.

15. The system of claim 1, further comprising a third input indicating a third vehicle condition, said third condition associated with a third indicator;
wherein said driver interface unit is in communication with said third input, said driver interface unit operable to modify said third indicator according to a priority between said first, second, and third vehicle conditions to create a second modified indicator, said driver interface unit operable to output said modified indicator, said other of said first and second indicators, and said second modified indicator generally simultaneously.

16. A method, comprising:
detecting a presence of a first vehicle condition, said first vehicle condition associated with a first indicator;
detecting a presence of a second vehicle condition, said second vehicle condition associated with a second indicator;
modifying one of said first and second indicators according to a priority between said first and second vehicle conditions to create a modified indicator; and
providing said modified indicator and the other of said first and second indicators to a driver interface unit, said modified indicator and said other of said first and second indicators provided generally simultaneously.

17. The method of claim 16, wherein said one of said first and second indicators is modified according to at least an intrusiveness of said first and second indicators.

18. The method of claim 16, further comprising determining that said one of said first and second indicators overlaps with said other of said first and second indicators.

19. The method of claim 16, further comprising:
receiving a predetermined priority scheme defining a relative priority between said first and second vehicle system conditions; and
determining said priority between said first and second vehicle conditions from said predetermined priority scheme.

20. The method of claim 16, including a plurality of different types of indicators, wherein modifying said one of said first and second indicators includes converting said one of said first and second indicators from a first type of indicator to a second type of indicator.

21. The method of claim 20, establishing said one of said first and second indicators as one of an audible indicator, a visual indicator, and a tactile feedback indicator, and establishing said modified indicator as a different one of said plurality of different types of indicators.

22. The method of claim 16, wherein said modified indicator is less intrusive than said one of said first and second indicators.

23.-29. (canceled)

30. The method of claim 16, further comprising
detecting a presence of a third vehicle condition, said third vehicle condition associated with a third indicator;
modifying said third indicator according to a priority between said first, second, and third vehicle conditions to create a second modified indicator; and
providing said modified indicator, said other of said first and second indicators, and said second modified indicator to a driver interface unit generally simultaneously.
